(19) United States
(12) Patent Application Publication
(10) Pub. No.: US 2004/0025009 A1
(43) Pub. Date: Feb. 5, 2004

(54) Method and apparatus for acceleration of multimedia content

(76) Inventors: August A. Camber, Rocklin, CA (US); Shawn C. Sackman, Shingle Springs, CA (US)

Correspondence Address: Timothy N. Trop, TROP, PRUNER & HU, P.C., STE 100, 8554 KATY FWY, Houston, TX, 77024-1841, US

(21) Appl. No.: 10/210,450

(22) Filed: Jul. 31, 2002

(51) Int. Cl. H04L 9/00; G06F 9/45

(52) U.S. Cl. 713/152; 717/140

(57) ABSTRACT

A method and apparatus for dynamically creating and storing statically compiled native code from platform independent bytecodes such as may be found in a Java™ multi-media application is described. A method and apparatus may be utilized that may include receiving a compressed multi-media application, decompressing the multi-media application into bytecode, compiling and may include optimizing the bytecode, in some embodiments, into optimized native code, saved for future invocation. Additionally, security features may be provided to prevent the utilization of compressed multi-media code in some embodiments.

### FIELD OF THE INVENTION

The disclosure relates to the field of computer processing.

### BACKGROUND

The Java™ language has become popular for use in distributing multi media content over the World Wide Web and other communication mediums. For example, a Java program, which may be compatible with a Java™ Language Specification, Second Edition, available from Sun Microsystems, Inc., San Jose, Calif., may be utilized to transfer code that includes graphics, sounds, text, or other compelling content to users, accessed through a specific World Wide Web site. Such content may inform the user of products or services provided by a particular vendor. In other situations, the Java™ code may provide entertainment for those that access the particular World Wide Web site.

The Java™ language is generally an interpreted language. Typically, application authors write general Java application bytecodes that may be interpreted by a device with a Java™ virtual machine that may be compatible with a Java™ Virtual Machine Specification, Second Edition, available from Sun Microsystems, Inc. The virtual Machine (VM) interprets the Java™ bytecodes such that the bytecodes may be executed on a target hardware platform that may utilize, for example, an Intel Pentium™ 4 microprocessor. Unfortunately, interpreted code is often non-linear and typically executes slowly on the target hardware platform. The often slow performance may be due to the performance differences between interpreted code and native code that may be directly executed by the target platform's processor.

As typically used, the Java™ applet is downloaded to a user's computer in a compressed form. The user's computer may uncompress the downloaded file into volatile memory, such as system RAM. An interpreter running on the user's computer may then translate each bytecode in a linear fashion from RAM and the translated code may then be executed on the user's computer. The translated code may be discarded when each execution instance is complete. This process typically uses a considerable amount of system RAM and by its nature and may not be optimized for code execution speed, or volatile memory use efficiency.

Therefore, what is needed, is a method and apparatus to provide for efficient Java code execution and other advantages.

### BRIEF DESCRIPTION OF THE DRAWINGS

The invention may best be understood by referring to the following description and accompanying drawings that are used to illustrate embodiments of the invention. In the drawings:

FIG. 1 is a schematic depiction of a processor-based system according to embodiments of the present invention.

FIG. 2 illustrates a communications link in accordance with embodiments of the present invention.

FIG. 3 is a data flow chart for the generation of executable native code according to embodiments of the present invention.

FIG. 4 is a flow chart for the generation of executable native code with security features according to embodiments of the present invention.

FIG. 5 illustrates a wireless communications link in accordance with embodiments of the present invention.

### DETAILED DESCRIPTION OF INVENTION

In the following description, numerous specification details are set forth to provide a detailed understanding of the present invention. However, one skilled in the art will readily appreciate that the present invention may be practiced without these specific details. For example, many of the described code segments may be consistent with versions of the Java™ programming language. This however is by way of example and not by way of limitation as other programming languages and structures may be similarly utilized.

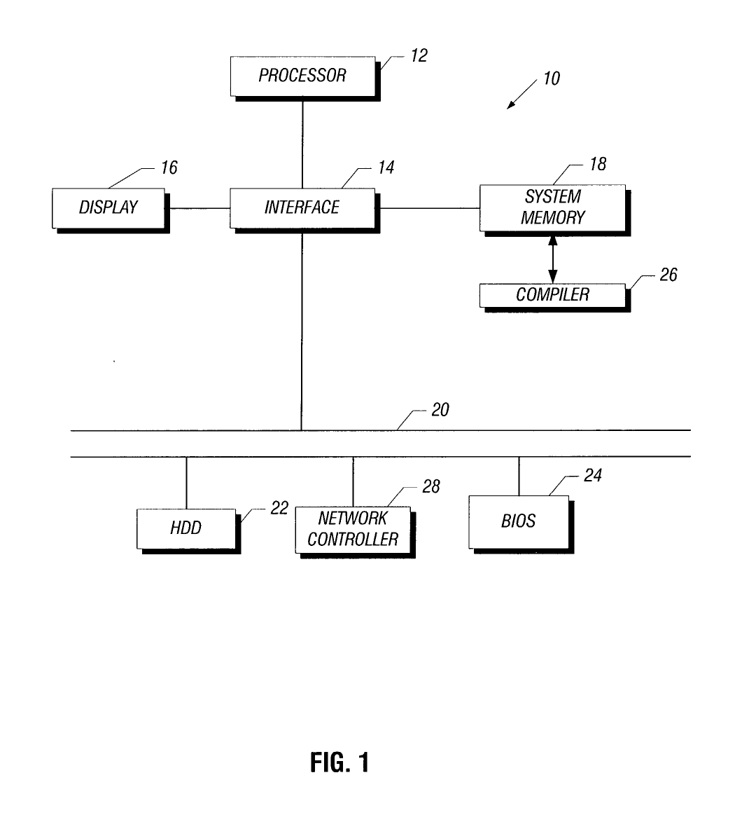

Referring to FIG. 1, a processor-base system 10 may include a processor 12 coupled to an interface 14. The interface 14, which may be a bridge, may be coupled to a display 16 or a display controller (not shown) and a system memory 18. The system memory 18 may include multiple dynamic random access memory devices (“DRAM”) or other devices as may be helpful to store application programs and other code in system 10. The interface 14 may also be coupled to one or more busses 20.

The bus 20, in turn, may be coupled to one or more storage devices 22, such as a hard disk drive (HDD). The hard disk drive 22, or other storage device, may store a variety of software including operating system code (not shown), compiler 26, and other code. A basic input/output system (BIOS) memory 24 may also be coupled to the bus 20 in some embodiments.

Of course, a wide variety of other processor-based system architecture may be utilized. In some embodiments, the compiler 26 and other support code may be stored on the hard disk 22, or other storage device, and may be subsequently loaded into system memory 18 as required by the system 10. The processor 12 may then execute instructions that cause the compiler 26 and other code to operate.

Additionally, in some embodiments, a network controller 28 may also be coupled to bus 20. The network controller 28 may provide for an interface to a communications network such as the World Wide Web or a wireless network, as two examples.

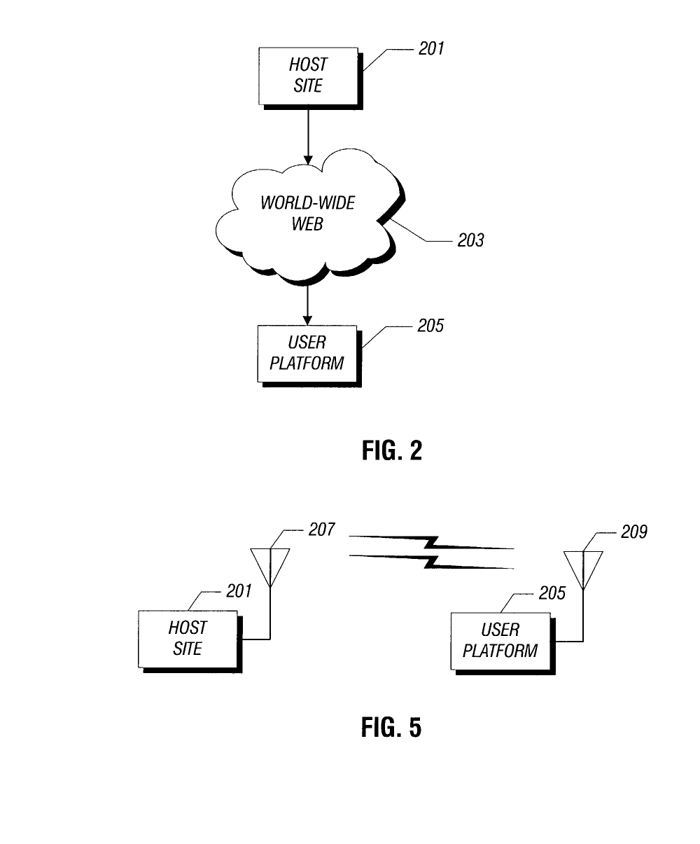

Referring now to FIG. 2, a host site 201 may host multi-media applications coded in Java™. These applications may be transferred to a communications network 203 such as the World Wide Web in some embodiments. The communications network 203 may then transfer the multi-media applications from the host site 201 to a user platform 205 that may be a processor-based system such as system 10.

Referring now to FIG. 5, a host site 201 may transfer Java based multi-media applications through a communications network that may include an antenna 207 or other wireless device to be utilized by the user platform 205. In some embodiments, the user platform 205 may be a processor-based system such as system 10. In other embodiments, the user platform 205 may be a wireless device such as, by way of example, a cell phone, personal digital assistant (PDA), or other device. The user platform 205 may be coupled to an antenna 209. The antenna 209 may be a dipole antenna, ground plane antenna or other antenna.

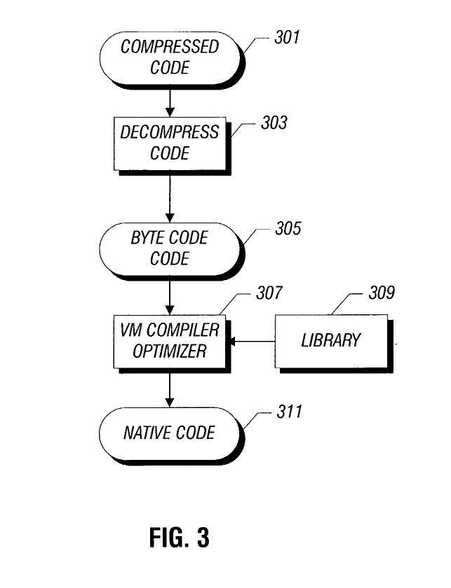

Referring now to FIG. 3, a compressed code 301 may be a compressed Java™ source program that may have been received over a communications network such as 203 or a wireless network. The compressed code 301 may, in some embodiments, be decompressed by a decompressor 303. This decompressor 303 may be a software program that takes as an input the compressed code 301 and outputs a decompressed code such as bytecode 305. Bytecode 305 may, in some embodiments, be a source code compatible with the Java™ programming language.

In some embodiments, a machine specific compiler is integrated into the virtual machine (VM) (307), removing one step of indirection. In this VM, 307 may take bytecode 305 as an input. Additionally, the interpreter 307, in some embodiments, may dynamically link optimized native code that may be found in a library 309, and then save the new binary in nonvolatile memory, ready for use upon the next instance of invocation from the VM.

The native code 311 may, in some embodiments, be executed from any available suitable memory in the system 10, without further interpretation, invoked by the virtual machine, or like module that provides this functionality. The process illustrated and described in association with FIG. 3, may provide for improved mobile code execution in managed execution environments.

For example, once the native code 311 has been generated, no further interpretation of the Java code is required for future invocations of the code, which may provide for a significant improvement in execution speed. In addition, the compiler 307 and library 309 may include code that provides for optimization of the generated native code for a particular platform such as system 10. The native code 311 may contain, in some embodiments, a complete static compilation of the full application code and therefore may, in some embodiments, not require run-time linking and run-time library utilizations.

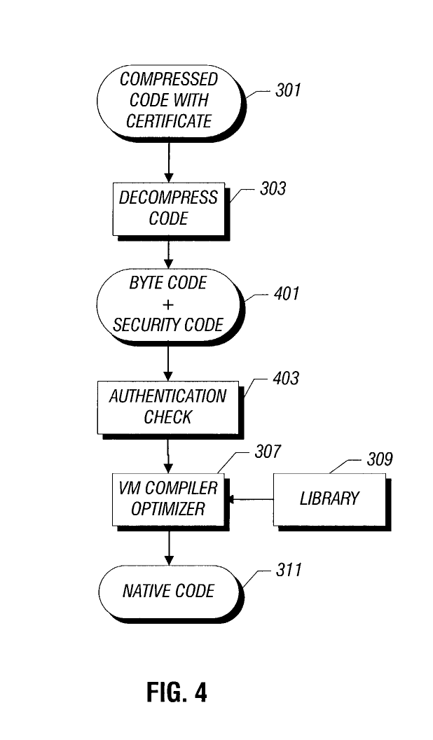

Referring now the FIG. 4, in some embodiments, the compressed code 301 may be decompressed by decompressed code 303 into bytecode and security code 401. The bytecode may be decompressed Java™ code as was described in association with FIG. 3. The security code may, for example, be a security certificate that was downloaded with the Java™ multi-media application.

In other embodiments, the security code may be some other code that is downloaded with the Java™ multi-media application that may indicate the application code is being provided or authorized by a particular source or provider.

The security code may be subject to a security check 403 to ensure the multimedia application can be trusted. This authorizes compilation/further runtime instances for the particular user platform. If the security check verifies that the code can be trusted, then the compiler 307 may compile the platform independent bytecode as was described in association with FIG. 3 above.

If however the security check fails, then the compiler 307 will be prevented from compiling the bytecode. In such a situation, the user may, in some embodiments, be notified that the security check 403 determined that the user or platform was not authorized to compile the compressed Java multimedia application 301.

While the present invention has been described with respect to a limited number of embodiments, those skilled in the art will appreciate numerous modifications and variations therefrom. For example, while the compiler and optimizer 307 are illustrated as a single program, the functionality of the compiler and optimizer may be split between a plurality of programs, code segment, libraries or other programming devices. Therefore, it is intended that the appended claims cover all such modifications and variations as fall within the true spirit and scope of this present invention.

What is claimed is:

1. A method comprising:
receiving compressed bytecode;
decompressing the received compressed bytecode; and
compiling the decompressed bytecode into native code at the application level, and storing in nonvolatile memory the native code.

2. The method of claim 1 further comprising:
receiving a security code; and
based, in part, on the content of the security code, compiling the decompressed bytecode into native code.

3. The method of claim 2 wherein:
receiving the security code includes receiving a security certificate.

4. The method of claim 2 wherein:
receiving the security code includes receiving information indicating the source of the compressed bytecode.

5. The method of claim 2 wherein:
receiving the security code includes receiving information indicating the provider of the compressed bytecode.

6. The method of claim 2 wherein:
receiving the security code includes receiving information indicating if the received bytecode may be compiled.

7. The method of claim 1 wherein:
compiling the decompressed bytecode into native code includes compiling the decompressed bytecode into a static compilation of a full application code.

8. The method of claim 7 wherein:
the static compilation of the decompressed bytecode is executable by a processor without use of a non-native run-time library.

9. The method of claim 8 wherein:
the static compilation of the downloaded bytecode is saved in nonvolatile memory.

10. The method of claim 1 further comprising:
receiving the compressed byte code from a communications network.

11. A machine-readable medium that provides instructions, that when executed by a set of one or more processors, enable the set of processors to perform operations comprising:
receiving compressed bytecode;
decompressing the received compressed bytecode;
compiling the decompressed bytecode into native code; and
storing native code in non-volatile memory

12. The native-readable medium of claim 11 further comprising:
receiving a security code; and
based, in part, on the content of the security code, compiling the decompressed bytecode into native code.

13. The native-readable medium of claim 11 wherein:
receiving the security code includes receiving a security certificate.

14. The native-readable medium of claim 11 wherein:
receiving the security code includes receiving information indicating the source of the compressed bytecode.

15. The native-readable medium of claim 11 wherein:
receiving the security code includes receiving information indicating the provider of the compressed bytecode.

16. The native-readable medium of claim 11 wherein:
receiving the security code includes receiving information indicating if the received bytecode may be compiled.

17. The native-readable medium of claim 11 wherein:
compiling the decompressed bytecode into native code includes compiling the decompressed bytecode into a static compilation of a full application code.

18. The native-readable medium of claim 11 wherein:
receiving the compressed bytecode from a communications network.

19. An apparatus comprising:
a dipole antenna coupled to a receiver to receive compressed bytecode;
a decompressor coupled to the receiver to decompress the received compressed bytecode; and
a compiler coupled to the receiver to compile the decompressed bytecode into native code.

20. The apparatus of claim 21 wherein the compressed bytecode is received from a communications network.

21. The apparatus of claim 21 wherein the compiler compiles the decompressed bytecode into native code that includes a static compilation of a full application code.

22. The apparatus of claim 21 further comprising:
the receiver receiving a security code; and
based, in part, on the content of the security code, the compiler compiling the decompressed bytecode into native code.

23. An apparatus comprising:
a dynamic random access memory (DRAM) memory device;
a receiver coupled to the DRAM to receive compressed bytecode;
a decompressor coupled to the DRAM to decompress the received compressed bytecode; and
a compiler coupled to the DRAM to compile the decompressed bytecode into native code.

24. The apparatus of claim 25 wherein the compressed bytecode is received from a communications network.

25. The apparatus of claim 25 wherein the compiler compiles the decompressed bytecode into native code that includes a static compilation of a full application code.

26. The apparatus of claim 25 further comprising:
the receiver receiving a security code; and
based, in part, on the content of the security code, the compiler compiling the decompressed bytecode into native code.
